(19) United States
(12) Patent Application Publication
(10) Pub. No.: US 2008/0104074 A1
(43) Pub. Date: May 1, 2008

(54) CASCADING SORT INTERFACE

(76) Inventor: Thomas W. Lynch, Galveston, TX (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/555,575

(22) Filed: Nov. 1, 2006

(51) Int. Cl. G06F 7/06

(52) U.S. Cl. 707/7

(57) ABSTRACT

Briefly, in accordance with one or more embodiments, a sort specification may be defined to sort a record array by one or more sort criteria.

### BACKGROUND

Operations to search and sort may be used hand in hand. Occasionally, searching a list of items may include sorting the list of items. For example, after searching a database, often multiple items may be returned. Sorting of the returned items may facilitate a user manually scanning through the returned items. For example, Internet search results may come back sorted by relevance; email programs may allow a sort of multiple emails by subject or the like; spread sheet programs may allow a sort of a table by one or more ordering functions for columns in the table; and/or data base queries may be returned in alphabetical order.

Email programs may include headers that may reference a given column of a table of email. A selection of one of these headers may sort the table of email in an alphabetic and/or numerical ordering based on the selected column. Alternatively, a user may select a column from a menu to sort the table of email in an alphabetic and/or numerical ordering based on the selected column.

Conversely, data items not viewed in columns may be sorted through a particular function based on information not necessarily found within the data items themselves. For example, Internet search results may be sorted via a given function that may determine the “relevance” of the data items.

Additionally, information may be sorted by more than one function. For example, some spread sheet programs may use a pull down menu for sorting information by more than one function. In this case, the menu typically displays a finite list of three choices such as, for example, “Sort By”, “Then By”, and “Then By”, with a pull down for each of these three choices.

### DESCRIPTION OF THE DRAWING FIGURES

Claimed subject matter is particularly pointed out and distinctly claimed in the concluding portion of the specification. However, both as to organization and/or method of operation, together with objects, features, and/or advantages thereof, it may best be understood by reference to the following detailed description when read with the accompanying drawings in which:

FIG. 1 is a block diagram of a computing platform in accordance with one or more embodiments;

FIG. 2 is a block diagram a record array in accordance with one or more embodiments;

FIG. 3 is a flow diagram of a procedure for specifying a sort specification for sorting a record array in accordance with one or more embodiments;

FIG. 4 is a diagram of a graphical user interface in accordance with one or more embodiments;

FIG. 5 is a diagram of a graphical user interface in accordance with one or more embodiments;

FIG. 6 is a flow diagram of a procedure for specifying a sort specification for sorting a record array in accordance with one or more embodiments;

FIG. 7 is a diagram of a graphical user interface in accordance with one or more embodiments;

FIG. 8 is a diagram of a graphical user interface in accordance with one or more embodiments;

FIG. 9 is a diagram of a graphical user interface in accordance with one or more embodiments;

FIG. 10 is a diagram of a graphical user interface in accordance with one or more embodiments;

FIG. 11 is a flow diagram of a procedure for specifying a sort specification for sorting a record array in accordance with one or more embodiments;

FIG. 12 is a diagram of a graphical user interface in accordance with one or more embodiments;

FIG. 13 is a diagram of a graphical user interface in accordance with one or more embodiments;

FIG. 14 is a diagram of a graphical user interface in accordance with one or more embodiments; and

FIG. 15 is a diagram of a graphical user interface in accordance with one or more embodiments.

Reference is made in the following detailed description to the accompanying drawings, which form a part hereof, wherein like numerals may designate like parts throughout to indicate corresponding or analogous elements. It will be appreciated that for simplicity and/or clarity of illustration, elements illustrated in the figures have not necessarily been drawn to scale. For example, the dimensions of some of the elements may be exaggerated relative to other elements for clarity. Further, it is to be understood that other embodiments may be utilized and structural and/or logical changes may be made without departing from the scope of the claimed subject matter. It should also be noted that directions and references, for example, up, down, top, bottom, and so on, may be used to facilitate the discussion of the drawings and are not intended to restrict the application of the claimed subject matter. Therefore, the following detailed description is not to be taken in a limiting sense and the scope of the claimed subject matter defined by the appended claims and their equivalents.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

Some portions of the detailed description that follow are presented in terms of algorithms, programs and/or symbolic representations of operations on data bits or binary digital signals within a computer memory, for example. These algorithmic descriptions and/or representations may include techniques used in the data processing arts to transfer the arrangement of a computing platform, such as a computer, a computing system, an electronic computing device, and/or other information handling system, to operate according to such programs, algorithms, and/or symbolic representations of operations. A program and/or process generally may be considered to be a self-consistent sequence of acts and/or operations leading to a desired result. These include physical manipulations of physical quantities. Usually, though not necessarily, these quantities take the form of electrical and/or magnetic signals capable of being stored, transferred, combined, compared, and/or otherwise manipulated. It has proven convenient at times, principally for reasons of common usage, to refer to these signals as bits, values, elements, symbols, characters, terms, numbers and/or the like. It should be understood, however, that all of these and/or similar terms are to be associated with the appropriate physical quantities and are merely convenient labels applied to these quantities. In addition, embodiments are not described with reference to any particular programming language. It will be appreciated that a variety of programming languages may be used to implement the teachings described herein.

Embodiments claimed may include one or more apparatuses for performing the operations herein. These apparatuses may be specially constructed for the desired purposes, or it may comprise a general purpose a computing platform, such as a computer, a computing system, an electronic computing device, and/or other information handling system, for example, selectively activated and/or reconfigured by a program stored in the device. The processes and/or displays presented herein are not inherently related to any particular computing platform and/or other apparatus. Various general purpose computing platforms may be used with programs in accordance with the teachings herein, or it may prove convenient to construct a more specialized computing platform to perform the desired method. The desired structure for a variety of these computing platforms will appear from the description below.

Embodiments claimed may include software capable of performing one or more of the operations described herein. Although the claimed subject matter is not limited in scope in this respect, one embodiment may be in hardware, such as implemented to operate on a device or combination of devices, whereas another embodiment may be in software. Likewise, an embodiment may be implemented in firmware, or as any combination of hardware, software, and/or firmware, for example. Likewise, although the claimed subject matter is not limited in scope in this respect, one embodiment may comprise one or more articles, such as a storage medium or storage media. This storage media may have stored thereon instructions that when executed by a computing platform, such as a computer, a computing system, an electronic computing device, and/or other information handling system, for example, may result in an embodiment of a method in accordance with the claimed subject matter being executed, for example.

In the following description and/or claims, the terms “storage medium” and/or “storage media” as referred to herein relate to media capable of maintaining expressions which are perceivable by one or more machines. For example, a storage medium may comprise one or more storage devices for storing machine-readable instructions and/or information. Such storage devices may comprise any one of several media types including, but not limited to, any type of magnetic storage media, optical storage media, semiconductor storage media, disks including floppy disks, optical disks, CD-ROMs, magnetic-optical disks, read-only memories (ROMs), random access memories (RAMs), electrically programmable read-only memories (EPROMs), electrically erasable and/or programmable read-only memories (EEPROMs), flash memory, magnetic and/or optical cards, and/or any other type of media suitable for storing electronic instructions, and/or capable of being coupled to a system bus for a computing platform. However, these are merely examples of a storage medium, and the scope of the claimed subject matter is not limited in this respect.

In the following description and/or claims, the term “instructions” as referred to herein relates to expressions which represent one or more logical operations. For example, instructions may be machine-readable by being interpretable by a machine for executing one or more operations on one or more data objects. However, this is merely an example of instructions, and the scope of claimed subject matter is not limited in this respect. In another example, instructions as referred to herein may relate to encoded commands which are executable by a processor having a command set which includes the encoded commands. Such an instruction may be encoded in the form of a machine language understood by the processor. However, these are merely examples of an instruction, and the scope of the claimed subject matter is not limited in this respect.

Unless specifically stated otherwise, as apparent from the following discussion, it is appreciated that throughout this specification discussions utilizing terms such as processing, computing, calculating, selecting, forming, enabling, inhibiting, identifying, initiating, receiving, transmitting, determining, displaying, sorting, delivering, appending, making and/or the like refer to the actions and/or processes that may be performed by a computing platform, such as a computer, a computing system, an electronic computing device, and/or other information handling system, that manipulates and/or transforms data represented as physical electronic and/or magnetic quantities and/or other physical quantities within the computing platform's processors, memories, registers, and/or other information storage, transmission, reception and/or display devices. Further, unless specifically stated otherwise, processes described herein, with reference to flow diagrams or otherwise, may also be executed and/or controlled, in whole or in part, by such a computing platform.

In the following description and/or claims, the term “and/or” as referred to herein may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

In the following description and/or claims, the terms “coupled” and/or “connected”, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other.

In the following description and/or claims, the term “digital object” as referred to herein relates to an object and/or information that is organized and/or formatted in a digitized form for use in a graphical user interface. For example, a digital object may comprise one or more of the following: a virtual widget, a virtual control object, a virtual interface component, a virtual window, a virtual text box, a virtual button, a virtual check box, a virtual menu, a virtual icon, a virtual toolbar, a virtual scroll bar, and/or the like, or combinations thereof. However, these are merely examples of digital objects, and the scope of the claimed subject matter is not limited in this respect.

Reference throughout this specification to “one embodiment” or “an embodiment” means that a particular feature, structure, or characteristic described in connection with the embodiment is included in at least one embodiment of the claimed subject matter. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

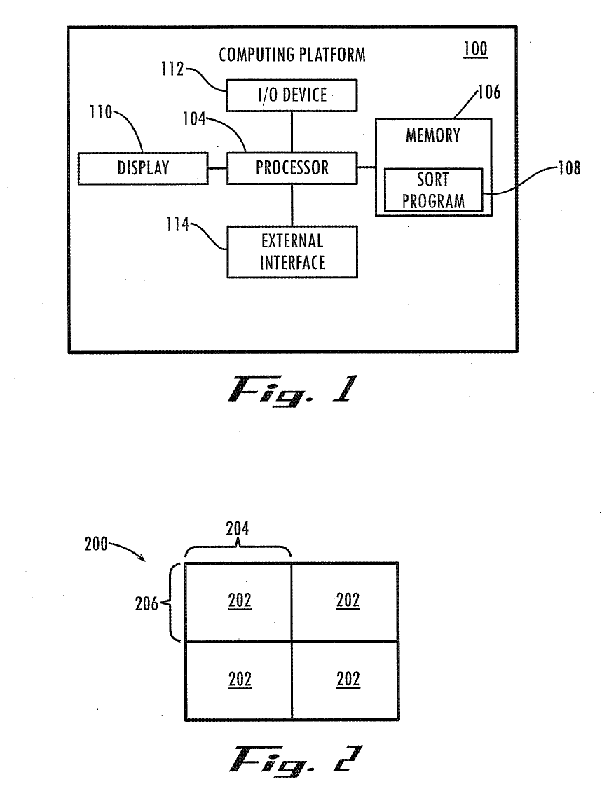

Referring to FIG. 1, a block diagram illustrates a computing platform 100 according to one or more embodiments, although the claimed subject matter is not limited in scope in this respect. Computing platform 100 may include more and/or fewer components than those shown in FIG. 1. However, generally conventional components may not be shown, for example, a battery, a bus, and so on.

Computing platform 100, as shown in FIG. 1 may be utilized to tangibly embody a computer program and/or graphical user interface by providing hardware components on which the computer program and/or graphical user interface may be executed. Such a computer program and/or machine readable instructions may be tangibly stored on a computer and/or machine readable storage medium such as a compact disk (CD), digital versatile disk (DVD), flash memory device, hard disk drive (HDD), and so on. As shown in FIG. 1, computing platform 100 may be controlled by processor 104, including one or more auxiliary processors (not shown). Processor 104 may comprise a central processing unit such as a microprocessor or microcontroller for executing programs, performing data manipulations, and controlling the tasks of computing platform 100. Auxiliary processors may manage input/output, perform floating point mathematical operations, manage digital signals, perform fast execution of signal processing algorithms, operate as a back-end processor and/or a slave-type processor subordinate to processor 104, operate as an additional microprocessor and/or controller for dual and/or multiple processor systems, and/or operate as a coprocessor and/or additional processor. Such auxiliary processors may be discrete processors and/or may be arranged in the same package as processor 104, for example, in a multicore and/or multithreaded processor; however, the scope of the claimed subject matter is not limited in these respects.

Communication with processor 104 may be implemented via a bus (not shown) for transferring information among the components of computing platform 100. A bus may include a data channel for facilitating information transfer between storage and other peripheral components of computing platform 100. A bus further may provide a set of signals utilized for communication with processor 104, including, for example, a data bus, an address bus, and/or a control bus. A bus may comprise any bus architecture according to promulgated standards, for example, industry standard architecture (ISA), extended industry standard architecture (EISA), micro channel architecture (MCA), Video Electronics Standards Association local bus (VLB), peripheral component interconnect (PCI) local bus, PCI express (PCIe), hyper transport (HT), standards promulgated by the Institute of Electrical and Electronics Engineers (IEEE) including IEEE 488 general-purpose interface bus (GPIB), IEEE 696/S-100, and so on, although the scope of the claimed subject matter is not limited in this respect.

Other components of computing platform 100 may include, for example, memory 106, including one or more auxiliary memories (not shown). Memory 106 may provide storage of instructions and data for programs to be executed by processor 104, such as sort program 108, for example. Memory 106 may be, for example, semiconductor-based memory such as dynamic random access memory (DRAM) and/or static random access memory (SRAM), and/or the like. Other semi-conductor-based memory types may include, for example, synchronous dynamic random access memory (SDRAM), Rambus dynamic random access memory (RDRAM), ferroelectric random access memory (FRAM), and so on. Alternatively or additionally, memory 106 may be, for example, magnetic-based memory, such as a magnetic disc memory, a magnetic tape memory, and/or the like; an optical-based memory, such as a compact disc read write memory, and/or the like; a magneto-optical-based memory, such as a memory formed of ferromagnetic material read by a laser, and/or the like; a phase-change-based memory such as phase change memory (PRAM), and/or the like; a holographic-based memory such as rewritable holographic storage utilizing the photorefractive effect in crystals, and/or the like; and/or a molecular-based memory such as polymer-based memories, and/or the like. Auxiliary memories may be utilized to store instructions and/or data that are to be loaded into memory 106 before execution. Auxiliary memories may include semiconductor based memory such as read-only memory (ROM), programmable read-only memory (PROM), erasable programmable read-only memory (EPROM), electrically erasable read-only memory (EEPROM), and/or flash memory, and/or any block oriented memory similar to EEPROM. Auxiliary memories also may include any type of non-semiconductor-based memories, including, but not limited to, magnetic tape, drum, floppy disk, hard disk, optical, laser disk, compact disc read-only memory (CD-ROM), write once compact disc (CD-R), rewritable compact disc (CD-RW), digital versatile disc read-only memory (DVD-ROM), write once DVD (DVD-R), rewritable digital versatile disc (DVD-RAM), and so on. Other varieties of memory devices are contemplated as well.

Computing platform 100 further may include a display 110. Display 110 may comprise a video display adapter having components, including, for example, video memory, a buffer, and/or a graphics engine. Such video memory may be, for example, video random access memory (VRAM), synchronous graphics random access memory (SGRAM), windows random access memory (WRAM, and/or the like. Display 110 may comprise a cathode ray-tube (CRT) type display such as a monitor and/or television, and/or may comprise an alternative type of display technology such as a projection type CRT type display, a liquid-crystal display (LCD) projector type display, an LCD type display, a light-emitting diode (LED) type display, a gas and/or plasma type display, an electroluminescent type display, a vacuum fluorescent type display, a cathodoluminescent and/or field emission type display, a plasma addressed liquid crystal (PALC) type display, a high gain emissive display (HGED) type display, and so forth.

Computing platform 100 further may include one or more I/O devices 112. I/O device 112 may comprise one or more I/O devices 112 such as a keyboard, mouse, trackball, touchpad, joystick, track stick, infrared transducers, printer, modem, RF modem, bar code reader, charge-coupled device (CCD) reader, scanner, compact disc (CD), compact disc read-only memory (CD-ROM), digital versatile disc (DVD), video capture device, TV tuner card, touch screen, stylus, electroacoustic transducer, microphone, speaker, audio amplifier, and/or the like.

Computing platform 100 further may include an external interface 114. External interface 114 may comprise one or more controllers and/or adapters to prove interface functions between multiple I/O devices 112. For example, external interface 114 may comprise a serial port, parallel port, universal serial bus (USB) port, and IEEE 1394 serial bus port, infrared port, network adapter, printer adapter, radio-frequency (RF) communications adapter, universal asynchronous receiver-transmitter (UART) port, and/or the like, to interface between corresponding I/O devices 112.

Referring to FIG. 2, a block diagram illustrates a record array 200 according to one or more embodiments, although the claimed subject matter is not limited in scope in this respect. Record array 200 may include more and/or fewer components than those shown in FIG. 2. However, generally conventional components may not be shown. Record array 200, as shown in FIG. 2 may comprises a viewable portion of one or more underlying data arrays and/or may itself comprise a data array. Record array 200 may be capable of displaying an ordered arrangement of one or more record fields 202. Record fields 202 may comprise a physical unit of data that is one or more bytes in size. A record column 204 may comprises a collection of two or more data fields 202 in a columnar arrangement. A record row 206 may comprises a collection of two or more data fields 202 in a row arrangement. In the sort program 108, a primary key may index and maintain the main sequence of the record array and/or underlying data array. For example, a primary key may comprise a column key capable of calling a column 204 from the record array 200 and/or underlying data array, and/or may comprise a row key capable of calling a row 206 from the record array 200 and/or underlying data array. A composite key may be capable of calling data in a customized manner other than by a specific field 202, by column 204, and/or by row 206, such as calling two or more fields 202, two or more columns 204, and/or two or more rows 206.

The record array 200 may be ordered via one or more sort criteria. A sort criterion, as used herein, may be any portion of sort program 108 capable of dictating the sequence of the record array 200. For example, a primary sort criterion may be capable of dictating the sequence of the record array such as by calling a record column 204 or by record row 206, for example via column key and/or row key. Similarly, a composite sort criterion may comprises a sort criterion capable of calling data in a customized manner other than by record column and/or by record row, such as by calling a composite key.

Referring now to FIG. 3, a flow diagram illustrates an example procedure for specifying a sort specification for sorting a record array 200 in accordance with one or more embodiments, although the claimed subject matter is not limited in scope in this respect. Procedure 300 illustrated in FIG. 3 may be used to specify a sort specification to sort a record array 200, for example, although the claimed subject matter is not limited in this respect. Additionally, although procedure 300, as shown in FIG. 3, comprises one particular order of blocks, the order in which the blocks are presented does not necessarily limit the claimed subject matter to any particular order. Likewise, intervening blocks shown in FIG. 3 and/or additional blocks not shown in FIG. 3 may be employed and/or blocks shown in FIG. 3 may be eliminated, without departing from the scope of the claimed subject matter.

Procedure 300 depicted in FIG. 3 may in alternative embodiments be implemented in software, hardware, and/or firmware, and may comprise discrete operations. As illustrated, procedure 300 starts at block 302 and proceeds to block 304 where an existing list of one or more sort criteria may be made empty. At block 306, an option to specify one or more initial sort criteria may be displayed. At block 308, a determination may be made as to if one or more sort criteria are specified. If no sort criterion is specified, the procedure 300 may start over at block 302. If a sort criterion is specified, at block 310, any specified sort criterion may be appended to a list of sort criterion, although the scope of the claimed subject matter is not limited in this respect. Alternatively or additionally, the record array 200 may be sorted based on the specified sort criterion when the sort criterion is specified, although the scope of the claimed subject matter is not limited in this respect.

At block 312, an option to request one or more additional sort criteria may be displayed. At block 314, a determination may be made as to if the option for additional sort criterion is requested. If the option for additional sort criterion is requested, at block 316, an option to specify one or more additional sort criteria is displayed and procedure 300 goes to block 308 to determine if one or more sort criteria are specified. Blocks 308, 310, 312, 314, and/or 316 may be performed multiple times during execution of procedure 300. If the option for additional sort criterion is not requested, at block 318, delivery may be made of a specified sort criterion list to sort the record array 200. At block 320, the record array 200 may be sorted based on the one or more specified sort criterion.

Referring now to FIG. 4 and FIG. 5, a representation of a graphical user interface is depicted in accordance with one or more embodiments, although the claimed subject matter is not limited in scope in this respect. The graphical user interface illustrated in FIG. 4 and FIG. 5 may comprise a menu 400 for a cascading sort. In operation, procedure 300 may provide an unlimited cascading sort and/or a cascading sort without a fixed depth. The procedure 300 may create a hierarchical list of two or more sort criterion for a cascading sort. For example, menu 400 may comprise one or more initial sort criteria digital objects 402, 404, and/or 406. Activation of the one or more initial sort criteria digital object(s) 402, 404, and/or 406 may provide access to one or more pull down digital objects 408. The first sort criterion specified may be the first item to sort the record array 200 by. Likewise the second sort criterion specified may be the first item to the record array 200 by, etc. Additionally or alternatively, as each sort criterion is specified, it may be given a numeric subscript and/or may be indented to distinguish if it is the first, second, etc. sort criterion specified for the cascading sort, although the scope of the claimed subject matter is not limited in this respect. Additional visual cues displaying the hierarchical nature of the specified cascading sort may be used herein.

Once a user specifies a first sort criterion, the user then has the option of completing the specification or making the specified sort criterion list longer. For example, menu 400 may also comprise an additional sort criterion digital option object 410. Activation of the additional sort criterion option digital object 410 may append an additional sort criterion digital object 500 to the list of initial sort criterion digital objects 402, 404, and/or 406. The activation of the additional sort criterion option digital object 410 may be done repeatedly to add as many additional sort criterion digital objects 500 as desired and/or within the limits of computer resources and/or within the artificial limits of program constraints. For example, a user may specify four or more sort criteria where there may be no predefined limit to the number of additional sort criterion digital objects 500 that may be requested, although the scope of the claimed subject matter is not limited in this respect. Menu 400 may also comprise an apply digital object 412. Activation of the apply digital object 412 may explicitly complete the specification of the sort criteria through the initial sort criterion digital objects 402, 404, and/or 406 and/or the one or more additional sort criteria digital objects 500, and trigger delivery of a specified sort criterion list for sorting the record array 200. Additionally or alternatively, record array 200 may be sorted as each sort criterion is specified, although the scope of the claimed subject matter is not limited in this respect. Additionally or alternatively, menu 400 may be replaced with a header-type menu and/or both menu. 400 and a header-type menu may be provided in the same sort program 108, although the scope of the claimed subject matter is not limited in this respect.

Referring now to FIG. 6, a flow diagram illustrates an example procedure for specifying a sort specification for sorting a record array 200 in accordance with one or more embodiments, although the claimed subject matter is not limited in scope in this respect. Procedure 600 illustrated in FIG. 6 may be used to specify a sort specification to sort a record array 200, for example, although the claimed subject matter is not limited in this respect. Additionally, although procedure 600, as shown in FIG. 6, comprises one particular order of blocks, the order in which the blocks are presented does not necessarily limit the claimed subject matter to any particular order. Likewise, intervening blocks shown in FIG. 6 and/or additional blocks not shown in FIG. 6 may be employed and/or blocks shown in FIG. 6 may be eliminated, without departing from the scope of the claimed subject matter.

Procedure 600 depicted in FIG. 6 may in alternative embodiments be implemented in software, hardware, and/or firmware, and may comprise discrete operations. As illustrated, procedure 600 starts at block 602 and proceeds to block 604 where an existing list of one or more sort criteria may be made empty. At block 606, a determination may be made as to if one or more column headers have been selected. If no column headers have been selected, the procedure 600 may start over at block 602. If column headers have been selected, at block 608, a determination may be made as to if sort start has been selected. If no sort start has been selected, procedure 600 goes to block 606 to determine if one or more column headers have been selected. Accordingly, multiple column headers may be selected in sequence prior to the sort start being selected at block 608, although the scope of the claimed subject matter is not limited in this respect. Alternatively or additionally, the record array 200 may be sorted based on the selected column headers when the column header is selected, although the scope of the claimed subject matter is not limited in this respect. At block 610, the record array 200 may be sorted based on the one or more column headers previously selected at block 606.

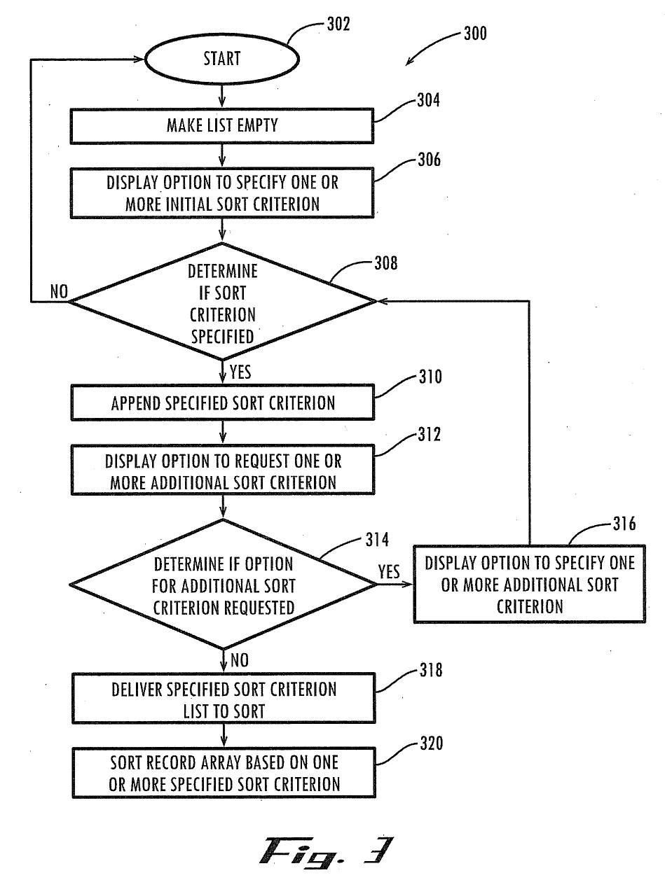

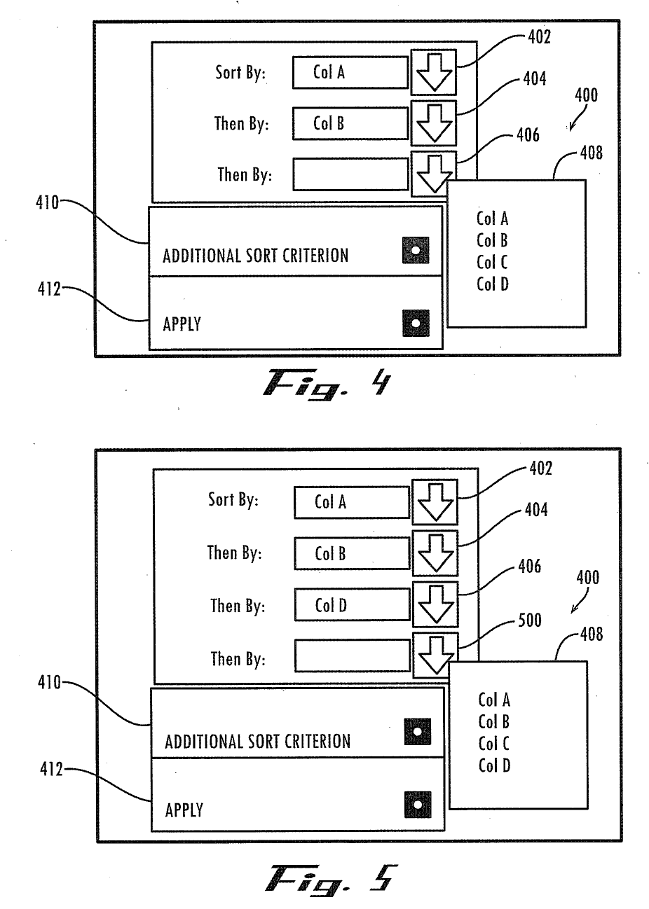

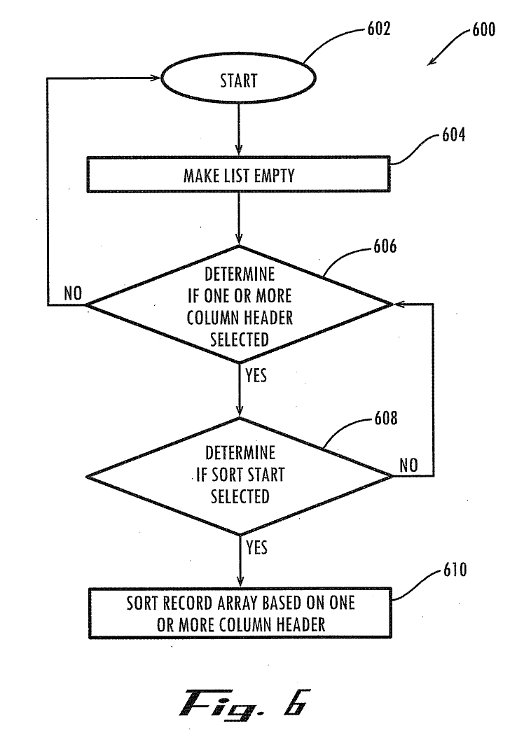

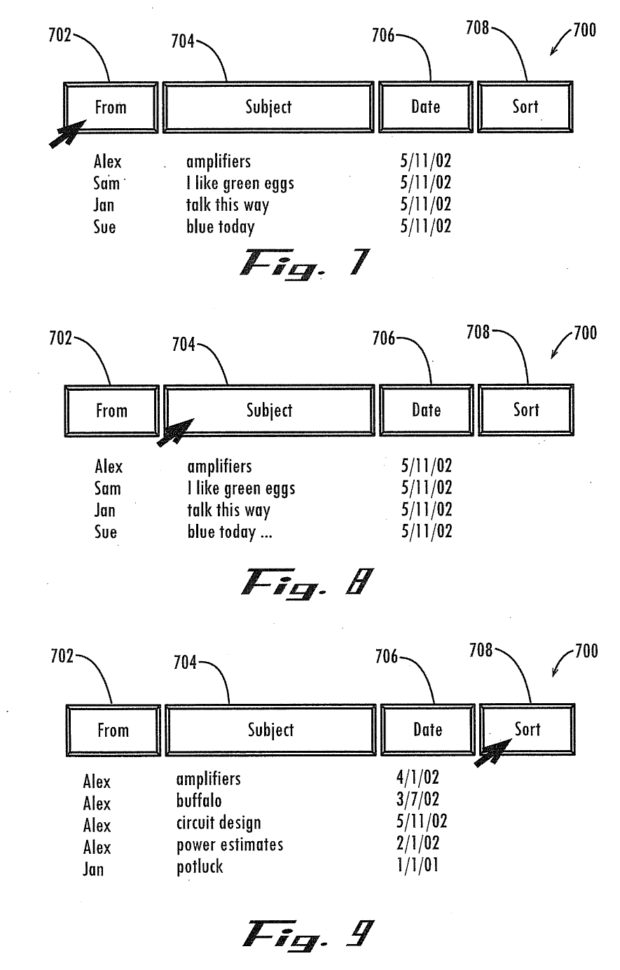

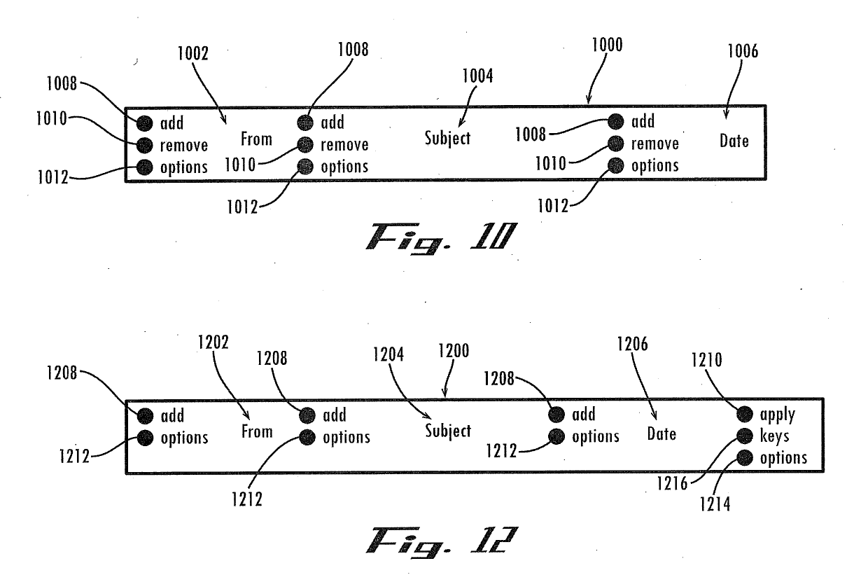

Referring now to FIG. 7 through FIG. 9, a representation of a graphical user interface is depicted in accordance with one or more embodiments, although the claimed subject matter is not limited in scope in this respect. The graphical user interface illustrated in FIG. 7 through FIG. 9 may comprise a record array 700 for a cascading sort. In operation, procedure 600 may provide a cascading sort via two or more column header digital objects. For example, record array 700 may comprise two or more header digital objects 702, 704, and/or 706. Activation of the one or more header digital object(s) 702, 704, and/or 706 may select a corresponding sort criterion used to sort the record array 700. For example, procedure 600 may determine if a first column header digital object 702 is selected by a user, as shown in FIG. 7; may determine if a second column header digital object 704 is selected by a user, as shown in FIG. 8; and may sort record array 700 based on the selected first column header digital object 702 and selected said second column header digital object, as shown in FIG. 9.

Specifically, as shown in FIG. 7, record array 700 remains sorted by the old sort criterion, or the default criterion, if any, while the user interacts with the screen to select first column header digital object 702 representing the “From” column. Selection of first column header digital object 702 may imply that a sort specification of procedure 600 is starting, and/or may also specify a first sort criterion. As shown in FIG. 8, the user may select second column header digital object 704 representing the “Subject” column. Selection of second column header digital object 704 may also specify a second sort criterion.

As shown in FIG. 9, the user may select sort start digital object 708 to explicitly indicate that a list of sort criterion is closed. For example, to trigger the sort, procedure 600 may determine if a sort start digital object 708 is selected by a user; and may sort record array 700 when sort start digital object 708 is selected by a user. Thus, the user may be presented with sort start digital object 708 as button indicating a complete list of sort criterion. Upon the user selecting sort start digital object 708, a list of sort criterion is sent to a sort routine, and the record array 700 is sorted according to the one or more selected header digital object(s) 702, 704, and/or 706 in a hierarchical cascading fashion.

Additionally or alternatively, sort start digital object 708 may be replaced with functionally equivalent objects and/or procedures. For example, a double click to one of header digital object(s) 702, 704, and/or 706 may be used to explicitly indicate that a list of sort criterion is closed and trigger a sort start, although the scope of the claimed subject matter is not limited in this respect. Further, a frame (not shown) may be placed around header digital object(s) 702, 704, and/or 706, where clicking on the frame might explicitly indicate that a list of sort criterion is closed and trigger a sort start, although the scope of the claimed subject matter is not limited in this respect.

Additionally or alternatively, sort start digital object 708 may stay down once selected until a new sort is specified, and/or sort start digital object 708 may stay down until the pointer leaves it, and/or sort start digital object 708 may stay down until the user lets up on the mouse button, although the scope of the claimed subject matter is not limited in this respect. Additionally or alternatively, selection of sort start digital object 708 may cause procedure 600 to ready itself for a new list of sort criterion; thus, digital objects 702, 704, and/or 706, and/or 708 may be displayed as popped back up to their quiescent states, although the scope of the claimed subject matter is not limited in this respect.

Alternatively or additionally, procedure 600 may sort record array 700 when one or more header digital object(s) 702, 704, and/or 706 are individually selected. For example, procedure 600 may sort record array 700 when first column header digital object 702 or second column header digital object 704 are selected, although the scope of the claimed subject matter is not limited in this respect. Accordingly, the start for sorting of record array 700 may be implied by the first selection of a header digital object 702, 704, and/or 706 at the top of a column. In which case, each time the user selects a header digital object(s) 702, 704, and/or 706, the list of sort criterion is assumed to be complete. Then successive selections of header digital objects 702, 704, and/or 706 may be accepted as successive sort criterion. In this manner, the sort may be incrementally updated after each header digital object(s) 702, 704, and/or 706 selection. Alternatively or additionally, sort start digital object 708 may operate as an explicit search specification start button capable of resetting the search, although the scope of the claimed subject matter is not limited in this respect. Accordingly, the list of sort criterion may be reset when the sort start digital object 708 is activated by a user, although the scope of the claimed subject matter is not limited in this respect.

Referring now to FIG. 10, a representation of a graphical user interface is depicted in accordance with one or more embodiments, although the claimed subject matter is not limited in scope in this respect. The graphical user interface illustrated in FIG. 10 may comprise a header area 1000 containing multiple digital objects for specifying a cascading sort. Header area 1000 may comprise digital objects for selection of a column header, where the digital objects may be smaller than the column widths, such as small circles over the columns, although the scope of the claimed subject matter is not limited in this respect. Additionally or alternatively, header area 1000 may comprise space within the header area 1000 to include many more digital objects such as, for example, a start search specification digital object, a complete search specification digital object, digital objects for other sort criterion including digital objects that are derived from functions, and search option selections.

For example, header area 1000 may comprise one or more predefined column header digital objects such as a from column header digital object 1002, a subject column header digital object 1004, and/or a date column header digital object 1006, although the scope of the claimed subject matter is not limited in this respect. Each column header digital object 1002, 1004, and/or 1006 may comprise an add digital object 1008, a remove digital object 1010, and/or an options digital object 1012. Activation of add digital object 1008 may select a sort criterion corresponding to column header digital object 1002, 1004, and/or 1006 used to sort the record array 700. For example, procedure 600 may determine if a first column header digital object 1002 is selected by a user when add digital object 1008 of from column header digital object 1002 is activated by a user. Similarly, activation of remove digital object 1010 may deselect a sort criterion corresponding to column header digital object 1002, 1004, and/or 1006 used to sort the record array 700. For example, procedure 600 may determine if a first column header digital object 1002 is deselected by a user when remove digital object 1010 of from column header digital object 1002 is activated by a user. Thus, the list of sort criterion may be incrementally updated and applied continuously as each column header digital object 1002, 1004, and/or 1006 is added or removed from the sort by activation of the corresponding add digital object 1008 or remove digital object 1010. Activation of options digital object 1012 may provide a user with additional sort options such as, for example, ascending order, descending order, sort top to bottom by rows, and/or sort left to right by column, etc., although the scope of the claimed subject matter is not limited in this respect.

Additionally or alternatively, the functionality of add digital object 1008, remove digital object 1010, and/or options digital object 1012 may be achieved through assigned shortcut keystrokes, assigned mouse button functionality, and/or combinations thereof, etc., although the scope of the claimed subject matter is not limited in this respect. Additionally or alternatively, as each column header digital object 1002, 1004, and/or 1006 is selected, it may be given a numeric subscript to distinguish if it is the first, second, etc. sort criterion specified for the cascading sort, although the scope of the claimed subject matter is not limited in this respect. Additional visual cues displaying the hierarchical nature of the specified cascading sort may be used herein.

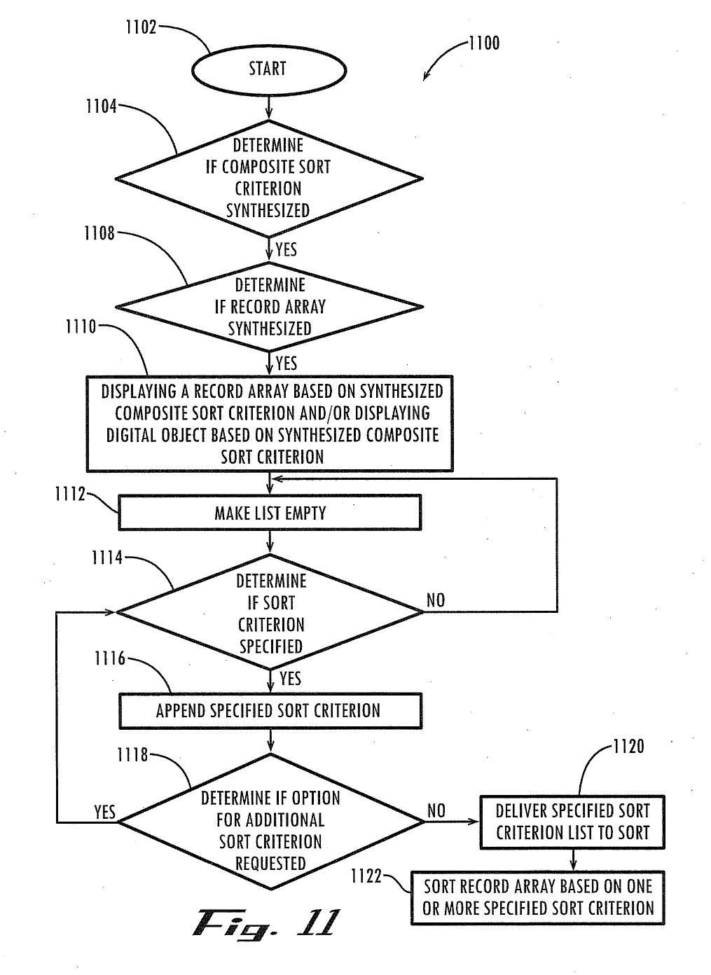

Referring now to FIG. 11, a flow diagram illustrates an example procedure for specifying a sort specification for sorting a record array 200 in accordance with one or more embodiments, although the claimed subject matter is not limited in scope in this respect. Procedure 1100 illustrated in FIG. 11 may be used to specify a sort specification to sort a record array 200, for example, although the claimed subject matter is not limited in this respect. Additionally, although procedure 1100, as shown in FIG. 11, comprises one particular order of blocks, the order in which the blocks are presented does not necessarily limit the claimed subject matter to any particular order. Likewise, intervening blocks shown in FIG. 11 and/or additional blocks not shown in FIG. 11 may be employed and/or blocks shown in FIG. 11 may be eliminated, without departing from the scope of the claimed subject matter.

Procedure 1100 depicted in FIG. 11 may in alternative embodiments be implemented in software, hardware, and/or firmware, and may comprise discrete operations. As illustrated, procedure 1100 starts at block 1102 and proceeds to block 1104 where a determination may be made as to if a composite sort criterion has been synthesized by a user. At block 1008, a determination may be made as to if a record array has been synthesized by a user. At block 1010, a record array may be formed and/or displayed based on the synthesized composite sort criterion and/or a digital object based on the synthesized composite sort criterion may be displayed.

Once a digital object based on the synthesized composite sort criterion is displayed, record array 200 may be sorted based at least in part on activation of the digital object based on the synthesized composite sort criterion to specify said composite sort criterion. For example, at block 1112 an existing list of one or more sort criteria may be made empty. At block 1114, a determination may be made as to if one or more sort criteria are specified, such as a synthesized composite sort criterion. If no sort criterion is specified, the procedure 1100 may start over at block 1112. If a sort criterion is specified, at block 1116, any specified sort criterion may be appended to a list of sort criterion, although the scope of the claimed subject matter is not limited in this respect. Alternatively or additionally, the record array 200 may be sorted based on the specified sort criterion when the sort criterion is specified, although the scope of the claimed subject matter is not limited in this respect.

At block 1118, a determination may be made as to if the option for additional sort criterion is requested. If the option for additional sort criterion is requested, procedure 1100 goes to block 1114 to determine if one or more sort criteria are specified. Blocks 1114, 1116, and/or 1118 may be performed multiple times during execution of procedure 1100. If the option for additional sort criterion is not requested, at block 1120, delivery may be made of a specified sort criterion list to sort the record array 200. At block 1122, the record array 200 may be sorted based on the one or more specified sort criterion, such as a synthesized composite sort criterion.

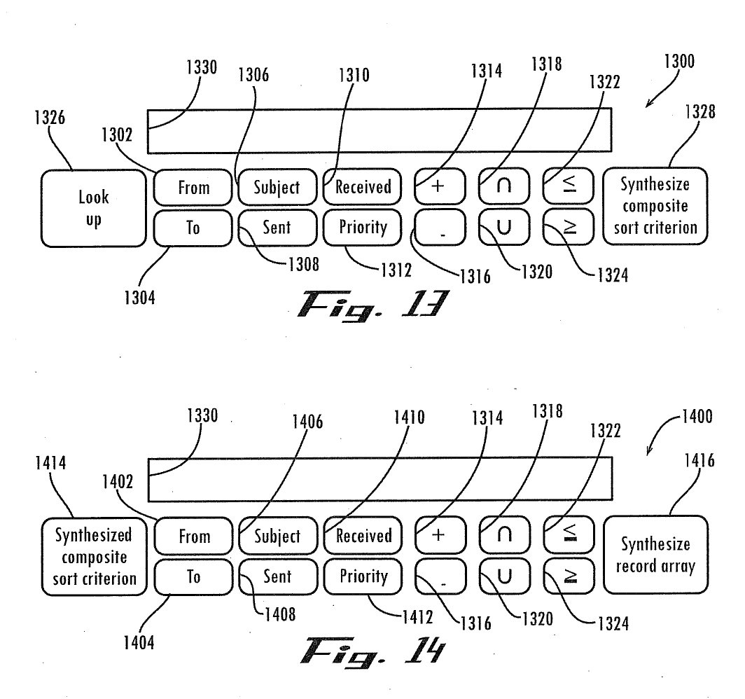

Referring now to FIG. 12, a representation of a graphical user interface is depicted in accordance with one or more embodiments, although the claimed subject matter is not limited in scope in this respect. The graphical user interface illustrated in FIG. 12 may comprise a header area 1200 containing multiple digital objects for specifying a cascading sort consistent with procedure 1100. Header area 1200 may comprise digital objects for selection of a column header, where the digital objects may be smaller than the column widths, such as small circles over the columns, although the scope of the claimed subject matter is not limited in this respect. Additionally or alternatively, header area 1200 may comprise space within the header area 1200 to include many more digital objects such as, for example, a start search specification digital object, a complete search specification digital object, digital objects for other sort criterion including digital objects that are derived from functions, and search option selections.

For example, header area 1200 may comprise one or more predefined column header digital objects such as a from column header digital object 1202, a subject column header digital object 1204, and/or a date column header digital object 1206, although the scope of the claimed subject matter is not limited in this respect. Each column header digital object 1202, 1204, and/or 1206 may comprise an add/remove digital object 1208 and/or an options digital object 1212. Selection of add/remove digital object 1208 may select a sort criterion corresponding to column header digital object 1202, 1204, and/or 1206 used to sort the record array 200; likewise, de-selection of add/remove digital object 1208 may deselect a previously selected sort criterion corresponding to column header digital object 1202, 1204, and/or 1206. For example, procedure 1100 may determine if a first column header digital object 1202 is selected by a user when add/remove digital object 1208 of from column header digital object 1202 is activated by a user; similarly, procedure 1100 may determine if a first column header digital object 1202 is deactivated by a user when add/remove digital object 1208 of from column header digital object 1202 is deselected by a user. Thus, the list of sort criterion may be incrementally updated and applied continuously as each column header digital object 1202, 1204, and/or 1206 is added or removed from the sort by activation or deactivation of the corresponding add/remove digital object 1208. Additionally or alternatively, header area 1200 may comprise an apply digital object 1210, although the scope of the claimed subject matter is not limited in this respect. Activation of the apply digital object 1210 may explicitly complete the specification of the sort criteria through the column header digital object 1202, 1204, and/or 1206, and trigger delivery of a specified sort criterion list for sorting the record array 200.

Activation of options digital object 1212 may provide a user with additional sort options such as, for example, ascending order, descending order, sort top to bottom by rows, and/or sort left to right by column, etc., although the scope of the claimed subject matter is not limited in this respect. Additionally or alternatively, header area 1200 may comprise an options digital object 1214 that may provide a user with additional global sort options for the entire array 200 such as, for example, ascending order, descending order, sort top to bottom by rows, and/or sort left to right by column, etc., although the scope of the claimed subject matter is not limited in this respect.

Header area 1200 may also comprise a key digital object 1216. Activation of a key digital object 1216 may provide access to one or more primary sort criterion not available through the displayed column header digital objects 1202, 1204, and/or 1206, and/or may provide access to one or more previously synthesized composite sort criterion, and/or may provide access to a criterion composer, and/or may provide access to record array composer. Additionally or alternatively, such a key digital object 1216 may also be provided in the menu 400 shown in FIGS. 4-5, although the claimed subject matter is not limited in scope in this respect.

Referring now to FIG. 13, a representation of a graphical user interface is depicted in accordance with one or more embodiments, although the claimed subject matter is not limited in scope in this respect. The graphical user interface illustrated in FIG. 13 may comprise a sort criterion composer 1300 containing multiple digital objects for specifying a cascading sort consistent with procedure 1100. Sort criterion composer 1300 may be used to create one or more synthesized composite sort criterion.

Sort criterion composer 1300 may comprise one or more digital objects for selection of data fields through primary keys and/or for selection of logic operators, although the scope of the claimed subject matter is not limited in this respect. For example, sort criterion composer 1300 may comprise one or more predefined sort criterion digital objects such as a from sort criterion digital object 1302, a to sort criterion digital object 1304, a subject sort criterion digital object 1306, a sent sort criterion digital object 1308, a received sort criterion digital object 1310, and/or a priority sort criterion digital object 1312. Similarly, sort criterion composer 1300 may comprise one or more logic operation digital objects such as an append digital object 1314, a remove digital object 1316, an intersection digital object 1318, a union digital object 1320, a less-than digital object 1322, and/or a greater-than digital object 1324.

Additionally or alternatively, sort criterion composer 1300 may comprise a look up digital object 1326. Activation of look up digital object 1326 may allow for accessing one or more predefined sort criterion not available from the displayed sort criterion digital objects 1302, 1304, 1306, 1308 1310, and/or 1312. For example, a predefined sort criterion may be available for the size of the items in record array, and may be accessed via the look up digital object 1326.

In operation, sort criterion composer 1300 may allow a user to compose a synthesized composite sort criterion using multiple operations in a step by step manner. For example, a user may interact with sort criterion composer 1300 to compose a synthesize composite sort criterion based on the logic operation digital objects 1314, 1316, 1318, 1320, 1322, and/or 1324 and/or based on sort criterion selected from look up digital object 1326 and/or selected from displayed sort criterion digital objects 1302, 1304, 1306, 1308 1310, and/or 1312. During composition, a display field 1330 may display the syntax of the composite sort criterion being composed. Once a synthesized composite sort criterion has been composed, a user may activate a synthesize composite sort criterion digital object 1328 to enter the synthesized composite sort criterion as a defined sort criterion for the process 1100. For example, a composite sort criterion may be synthesized to sort for all mail older than Jan. 1, 1999 by the user activating the received sort criterion digital object 1310, followed by activating the greater-than digital object 1324, and then by typing in Jan. 1, 1999, although the scope of the claimed subject matter is not limited in this respect. Additionally or alternatively, a special composers (not shown) could be used to help the user type in syntactically correct items such as dates such as via a pop-up a menu allowing the user to pick the date off a calendar, although the scope of the claimed subject matter is not limited in this respect.

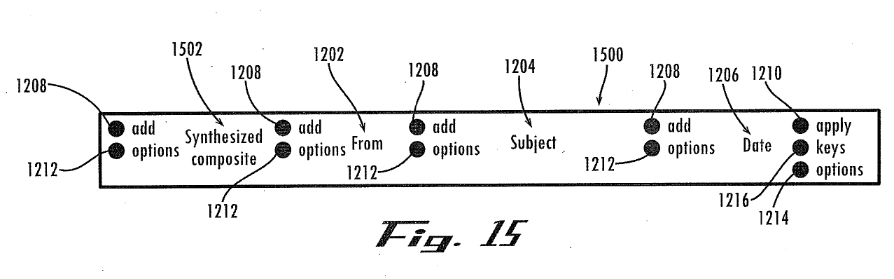

Referring now to FIG. 14, a representation of a graphical user interface is depicted in accordance with one or more embodiments, although the claimed subject matter is not limited in scope in this respect. The graphical user interface illustrated in FIG. 14 may comprise a record array composer 1400 containing multiple digital objects for specifying a cascading sort consistent with procedure 1100. Sort criterion composer 1300 may be used to create one or more synthesized record arrays.

Record array composer 1400 may comprise one or more digital objects for selection of columns to include in the record array 200 and/or for selection of logic operators, although the scope of the claimed subject matter is not limited in this respect. For example, record array composer 1400 may comprise one or more predefined column header digital objects such as a from column header digital object 1402, a to column header digital object 1404, a subject column header digital object 1406, a sent column header digital object 1408, a received column header digital object 1410, and/or a priority column header digital object 1412. Similarly, record array composer 1400 may comprise one or more logic operation digital objects such as append digital object 1314, remove digital object 1316, intersection digital object 1318, union digital object 1320, less-than digital object 1322, and/or greater-than digital object 1324.

Additionally or alternatively, the one or more predefined column header digital objects of record array composer 1400 may comprise one or more synthesized composite sort criterion digital objects 1414. For example, composite sort criterion digital objects 1414 may be based on a composite sort criterion synthesized via the sort criterion composer 1300 of FIG. 13. Activation of synthesized composite sort criterion digital objects 1414 may allow for synthesizing record array based at least in part on the sort criterion of synthesized composite sort criterion digital objects 1414.

In operation, record array composer 1400 may allow a user to compose a synthesized record array using multiple operations in a step by step manner. For example, a user may interact with record array composer 1400 to compose a synthesized record array based on the logic operation digital objects 1314, 1316, 1318, 1320, 1322, and/or 1324 and/or based on one or more synthesized composite sort criterion digital objects 1414 and/or selected from displayed column header digital objects 1402, 1404, 1406, 1408 1410, and/or 1412. During composition, a display field 1330 may display the syntax of the synthesized record array being composed. Once a synthesized record array has been composed, a user may activate a synthesize record array digital object 1416 to sort and display a record array 200 as a defined for the process 1100.

For example, record array composer 1400 may be used to drive a search engine, although the scope of the claimed subject matter is not limited in this respect. For example, record array composer 1400 may be used to search for email on the Internet. To specify the search, record array composer 1400 may specify various information such as who the email was from, who the email was too, what date ranges, etc., and produce a record array 200 based on the result.

Referring now to FIG. 15, a representation of a graphical user interface is depicted in accordance with one or more embodiments, although the claimed subject matter is not limited in scope in this respect. The graphical user interface illustrated in FIG. 15 may comprise a header area 1500 containing multiple digital objects for specifying a cascading sort consistent with procedure 1100. Header area 1500 is similar to header area 1200 of FIG. 12, and like elements are numbered accordingly. Header area 1500 may comprise a synthesized composite column header digital object 1502 for selection of a column header based on a composite sort criteria previously synthesized by a user. For example, synthesized composite column header digital object 1502 may be based on a composite sort criteria previously synthesized by a user via sort criterion composer 1300 of FIG. 13. Additionally or alternatively, such a synthesized composite column header digital object 1502 may also be provided in the menu 400 shown in FIGS. 4-5 and/or in columnar record array 700 shown in FIGS. 7-9, although the claimed subject matter is not limited in scope in this respect.

In the preceding description, various aspects of the claimed subject matter have been described. For purposes of explanation, specific numbers, systems and/or configurations were set forth to provide a thorough understanding of the claimed subject matter. However, it should be apparent to one skilled in the art having the benefit of this disclosure that the claimed subject matter may be practiced without the specific details. In other instances, well-known features were omitted and/or simplified so as not to obscure the claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of the claimed subject matter.

What is claimed is:

1. A method, comprising:
displaying an option to specify one or more initial sort criteria to sort a record array;
displaying an option to request one or more additional sort criteria;
displaying an option to specify one or more additional sort criteria if one or more additional sort criteria are requested by a user; and
sorting the record array one or more times based at least in part on the one or more initial criteria and/or based at least in part on the one or more additional criteria, or combinations thereof in accordance with a user selection.

2. The method of claim 1, wherein said one or more initial sort criteria and said one or more additional sort criteria comprise four or more sort criteria.

3. The method of claim 1, wherein there is no predefined limit to the number of said one or more additional sort criteria that may be requested.

4. The method of claim 1, further comprising:
repeating said displaying of the option to request one or more additional sort criteria; and
repeating said displaying of the option to specify one or more additional sort criteria if one or more additional sort criteria are requested by a user.

5. An article comprising: a storage medium having stored thereon instructions, that, if executed, result in:
displaying an option to specify one or more initial sort criteria to sort a record array;
displaying an option to request one or more additional sort criteria;
displaying an option to specify one or more additional sort criteria if one or more additional sort criteria are requested by a user; and
sorting the record array one or more times based at least in part on the one or more initial criteria and/or based at least in part on the one or more additional criteria, or combinations thereof in accordance with a user selection.

6. The article of claim 5, wherein said one or more initial sort criteria and said one or more additional sort criteria comprise four or more sort criteria.

7. The article of claim 5, wherein there is no predefined limit to the number of said one or more additional sort criteria that may be requested.

8. The article of claim 5, wherein the instructions, if executed, further result in:
repeating said displaying of the option to request one or more additional sort criteria; and
repeating said displaying of the option to specify one or more additional sort criteria if one or more additional sort criteria are requested by a user.

9. An apparatus, comprising:
means for displaying an option to specify one or more initial sort criteria to sort a record array;
means for displaying an option to request one or more additional sort criteria;
means for displaying an option to specify one or more additional sort criteria if one or more additional sort criteria are requested by a user; and
means for sorting the record array one or more times based at least in part on the one or more initial criteria and/or based at least in part on the one or more additional criteria, or combinations thereof in accordance with a user selection.

10. The apparatus of claim 9, wherein said one or more initial sort criteria and said one or more additional sort criteria comprise four or more sort criteria.

11. The apparatus of claim 9, wherein there is no predefined limit to the number of said one or more additional sort criteria that may be requested.

12. The apparatus of claim 9, further comprising:
means for repeating said displaying of the option to request one or more additional sort criteria; and
means for repeating said displaying of the option to specify one or more additional sort criteria if one or more additional sort criteria are requested by a user.

13. A method, comprising:
determining if a first column header digital object is selected by a user;
determining if a second column header digital object is selected by a user; and
sorting a record array based on selected said first column header digital object and selected said second column header digital object.

14. The method of claim 13, further comprising sorting the record array upon selection of said first column header digital object or said second column header digital object.

15. The method of claim 13, further comprising:
determining if a sort start digital object is selected by a user; and
sorting said record array upon selection of said sort start digital object by a user.

16. The method of claim 13, further comprising:
displaying an option to request one or more additional sort criteria; and
displaying an option to specify one or more additional sort criteria if one or more additional sort criteria are requested by a user.

17. The method of claim 13, further comprising:
displaying an option to request one or more additional sort criteria;
displaying an option to specify one or more additional sort criteria if one or more additional sort criteria are requested by a user;
repeating said displaying of the option to request one or more additional sort criteria; and
repeating said displaying of the option to specify one or more additional sort criteria if one or more additional sort criteria are requested by a user.

18. An article comprising: a storage medium having stored thereon instructions, that, if executed, result in:
determining if a first column header digital object is selected by a user;
determining if a second column header digital object is selected by a user; and
sorting a record array based on selected said first column header digital object and selected said second column header digital object.

19. The article of claim 18, wherein the instructions, if executed, further result in sorting the record array upon selection of said first column header digital object or said second column header digital object.

20. The article of claim 18, wherein the instructions, if executed further result in:
determining if a sort start digital object is selected by a user; and
sorting said record array upon selection of said sort start digital object by a user.

21. The article of claim 18, wherein the instructions, if executed further result in:
displaying an option to request one or more additional sort criteria; and
displaying an option to specify one or more additional sort criteria if one or more additional sort criteria are requested by a user.

22. The article of claim 18, wherein the instructions, if executed further result in:
displaying an option to request one or more additional sort criteria;
displaying an option to specify one or more additional sort criteria if one or more additional sort criteria are requested by a user;
repeating said displaying of the option to request one or more additional sort criteria; and
repeating said displaying of the option to specify one or more additional sort criteria if one or more additional sort criteria are requested by a user.

23. An apparatus, comprising:
means for determining if a first column header digital object is selected by a user;
means for determining if a second column header digital object is selected by a user; and
means for sorting a record array based on selected said first column header digital object and selected said second column header digital object.

24. The apparatus of claim 23, further comprising means for sorting the record array upon selection of said first column header digital object or said second column header digital object.

25. The apparatus of claim 23, further comprising:
means for determining if a sort start digital object is selected by a user; and
means for sorting said record array upon selection of said sort start digital object by a user.

26. The apparatus of claim 23, further comprising:
means for displaying an option to request one or more additional sort criteria; and
means for displaying an option to specify one or more additional sort criteria if one or more additional sort criteria are requested by a user.

27. The apparatus of claim 23, further comprising:
means for displaying an option to request one or more additional sort criteria;
means for displaying an option to specify one or more additional sort criteria if one or more additional sort criteria are requested by a user;
means for repeating said displaying of the option to request one or more additional sort criteria; and
means for repeating said displaying of the option to specify one or more additional sort criteria if one or more additional sort criteria are requested by a user.

28. A method, comprising:
displaying a record array;
displaying a first digital object based on a composite sort criterion; and
sorting said record array based at least in part on activation of said first digital object to specify said composite sort criterion.

29. The method of claim 28, wherein said composite sort criterion comprises a sort criterion capable of calling data in a customized manner other than by record column and/or by record row.

30. The method of claim 28, wherein said composite sort criterion comprises a sort criterion capable of calling data in a customized manner other than by record column and/or by record row; and wherein said composite sort criterion comprises a composite sort criterion previously synthesized by a user.

31. The method of claim 28, further comprising:
determining if a first column header digital object is selected by a user;
determining if a second column header digital object is selected by a user; and
sorting said record array based on selected said first column header digital object and selected said second column header digital object.

32. The method of claim 28, further comprising:
determining if a first column header digital object is selected by a user;
determining if a second column header digital object is selected by a user;
sorting said record array based on selected said first column header digital object and selected said second column header digital object; and
wherein said first digital object comprises said first column header digital object and/or said second column header digital object.

33. The method of claim 28, further comprising:
determining if said first digital object is selected by a user; and
sorting said record array upon selection of said first digital object.

34. The method of claim 28, further comprising:
determining if a sort start digital object is selected by a user; and
sorting said record array when said sort start digital object is selected by a user.

35. The method of claim 28, further comprising:
displaying an option to request one or more additional sort criteria; and
displaying an option to specify one or more additional sort criteria if one or more additional sort criteria are requested by a user.

36. The method of claim 28, further comprising:
displaying an option to request one or more additional sort criteria;
displaying an option to specify one or more additional sort criteria if one or more additional sort criteria are requested by a user;
repeating said displaying of the option to request one or more additional sort criteria; and
repeating said displaying of the option to specify one or more additional sort criteria if one or more additional sort criteria are requested by a user.

37. An article comprising: a storage medium having stored thereon instructions, that, if executed, result in:
displaying a record array;
displaying a first digital object based on a composite sort criterion; and
sorting said record array based at least in part on activation of said first digital object to specify said composite sort criterion.

38. The article of claim 37, wherein said composite sort criterion comprises a sort criterion capable of calling data in a customized manner other than by record column and/or by record row.

39. The article of claim 37, wherein said composite sort criterion comprises a sort criterion capable of calling data in a customized manner other than by record column and/or by record row; and wherein said composite sort criterion comprises a composite sort criterion previously synthesized by a user.

40. The article of claim 37, wherein the instructions, if executed further result in:
determining if a first column header digital object is selected by a user;
determining if a second column header digital object is selected by a user; and
sorting said record array based on selected said first column header digital object and selected said second column header digital object.

41. The article of claim 37, wherein the instructions, if executed further result in:
determining if a first column header digital object is selected by a user;
determining if a second column header digital object is selected by a user;
sorting said record array based on selected said first column header digital object and selected said second column header digital object; and
wherein said first digital object comprises said first column header digital object and/or said second column header digital object.

42. The article of claim 37, wherein the instructions, if executed further result in:
determining if said first digital object is selected by a user; and
sorting said record array upon selection of said first digital object.

43. The article of claim 37, wherein the instructions, if executed further result in:
determining if a sort start digital object is selected by a user; and
sorting said record array when said sort start digital object is selected by a user.

44. The article of claim 37, wherein the instructions, if executed further result in:
displaying an option to request one or more additional sort criteria; and
displaying an option to specify one or more additional sort criteria if one or more additional sort criteria are requested by a user.

45. The article of claim 37, wherein the instructions, if executed further result in:
displaying an option to request one or more additional sort criteria;
displaying an option to specify one or more additional sort criteria if one or more additional sort criteria are requested by a user;
repeating said displaying of the option to request one or more additional sort criteria; and
repeating said displaying of the option to specify one or more additional sort criteria if one or more additional sort criteria are requested by a user.

46. An apparatus, comprising:
means for displaying a record array;
means for displaying a first digital object based on a composite sort criterion; and
means for sorting said record array based at least in part on activation of said first digital object to specify said composite sort criterion.

47. The apparatus of claim 46, wherein said composite sort criterion comprises a sort criterion capable of calling data in a customized manner other than by record column and/or by record row.

48. The apparatus of claim 46, wherein said composite sort criterion comprises a sort criterion capable of calling data in a customized manner other than by record column and/or by record row; and wherein said composite sort criterion comprises a composite sort criterion previously synthesized by a user.

49. The apparatus of claim 46, further comprising:
means for determining if a first column header digital object is selected by a user;
means for determining if a second column header digital object is selected by a user; and
means for sorting said record array based on selected said first column header digital object and selected said second column header digital object.

50. The apparatus of claim 46, further comprising:
means for determining if a first column header digital object is selected by a user;
means for determining if a second column header digital object is selected by a user;
means for sorting said record array based on selected said first column header digital object and selected said second column header digital object; and
wherein said first digital object comprises said first column header digital object and/or said second column header digital object.

51. The apparatus of claim 46, further comprising:
means for determining if said first digital object is selected by a user; and
means for sorting said record array upon selection of said first digital object.

52. The apparatus of claim 46, further comprising:
means for determining if a sort start digital object is selected by a user; and
means for sorting said record array when said sort start digital object is selected by a user.

53. The apparatus of claim 46, further comprising:
means for displaying an option to request one or more additional sort criteria; and
means for displaying an option to specify one or more additional sort criteria if one or more additional sort criteria are requested by a user.

54. The apparatus of claim 46, further comprising:
means for displaying an option to request one or more additional sort criteria;
means for displaying an option to specify one or more additional sort criteria if one or more additional sort criteria are requested by a user;
means for repeating said displaying of the option to request one or more additional sort criteria; and
means for repeating said displaying of the option to specify one or more additional sort criteria if one or more additional sort criteria are requested by a user.

55. An apparatus, comprising:
means for displaying a record array;
means for displaying an option to request one or more additional sort criteria;
means for displaying an option to specify one or more additional sort criteria if one or more additional sort criteria are requested by a user;
means for determining if a first column header digital object is selected by a user;
means for determining if a second column header digital object is selected by a user;
wherein one or more of said first column header digital object and/or said second column header digital object is based on a composite sort criterion; and
means for sorting said record array based on selected said first column header digital object and selected said second column header digital object.

56. The apparatus of claim 55, wherein said composite sort criterion comprises a sort criterion capable of calling data in a customized manner other than by record column and/or by record row.

57. The apparatus of claim 55, wherein said composite sort criterion comprises a sort criterion capable of calling data in a customized manner other than by record column and/or by record row; and wherein said composite sort criterion comprises a composite sort criterion previously synthesized by a user.

58. The apparatus of claim 55, further comprising means for sorting said record array if said first column header digital object or said second column header digital object are selected.

59. The apparatus of claim 55, further comprising:
means for determining if a sort start digital object is selected by a user; and
means for sorting said record array if said sort start digital object is selected by a user.

60. The apparatus of claim 55, further comprising:
means for repeating said displaying of the option to request one or more additional sort criteria; and
means for repeating said displaying of the option to specify one or more additional sort criteria if one or more additional sort criteria are requested by a user.
